(19) United States
(12) Patent Application Publication
(10) Pub. No.: US 2021/0386616 A1
(43) Pub. Date: Dec. 16, 2021

(54) BODY SHAPING STICK

(71) Applicant: Ningbo Juyang Electronic Commerce Co., Ltd., Ningbo (CN)

(72) Inventor: Lan Sun, Ningbo (CN)

(21) Appl. No.: 17/446,612

(22) Filed: Aug. 31, 2021

(30) Foreign Application Priority Data
Aug. 20, 2021 (CN) 202110962575.1

(51) Int. Cl. A61H 15/00

(52) U.S. Cl. CPC A61H 15/0092; A61H 2201/1253; A61H 2201/14

(57) ABSTRACT

The present disclosure discloses a body shaping stick, and relates to the field of medical health-care instruments. The body shaping stick includes a stick body (1). At least one end part of the stick body (1) is provided with a removable first holding part (2); a free end part of the first holding part (2) is at least set to be spherical for a user to hold and conduct various fitness operations; and the free end part of the first holding part (2) may rotate under the action of a force. The first holding part is removably and rotatably mounted at the end part of the stick body of the body shaping stick, so the first holding part can rotate under a palm acting force during use and has higher flexibility. Furthermore, one or two holding parts can be selectively mounted according to the need of a user, which is more humanized.

### TECHNICAL FIELD

The present disclosure relates to the field of medical health-care instruments, and specifically relates to a body shaping stick.

### BACKGROUND ART

With the acceleration of the pace of modern life and the reduction of exercise time, more and more modern people are plagued by health problems. For example, sitting at a desk for a long time will make muscles tense for a long time, which can easily cause cervical spine fatigue, lumbar muscle strain, coccyx injury, fat tissue deposit and even muscle atrophy.

Therefore, a body shaping stick that is relatively small in volume, easy to move and can be used at home is favored by more and more people. With the body shaping stick, various fitness, slimming and stretching actions can be done, which can help relax and exercise muscles.

Most of existing body shaping sticks on the market are designed in one piece. End parts for a user to hold are not removable, non-rotatable and not flexible, and cannot be assembled on demand according to user's wishes. There are also some body shaping sticks that are detachable, but removed parts cannot be used alone and have a monotonous function.

### SUMMARY

The present disclosure aims to provide a body shaping stick to solve the problems that all components of the body shaping stick in the existing art, particular an end part for a user to hold, are not rotatable, cannot be assembled on demand, and have a monotonous function.

In order to solve the above-mentioned problems, the technical solutions adopted in the present disclosure are as follows.

A body shaping stick includes a stick body (1). At least one end part of the stick body (1) is provided with a removable first holding part (2); a free end part of the first holding part (2) is at least set to be spherical for a user to hold and conduct various fitness operations; and the free end part of the first holding part (2) may rotate under the action of a force.

Further, the first holding part (2) includes a connection pipe (3) and a spherical connection cap (4) rotatably connected to an end part of the connection part (3); the connection pipe (3) is at least provided with two end parts; the connection cap is set to be a through hole structure; and at least one end part of the connection pipe (3) is set to allow the stick body (1) to be plugged and to fix the stick body (1).

Much further, the connection pipe (3) includes a linear two-way connection pipe, a curved two-way connection pipe with a certain angle, a three-way connection pipe a cross type four-way connection pipe, or various other multi-way connection pipes; the connection cap (4) is rotatably connected to each end part of the connection pipe (3) to form the first holding part (2) of different structures.

Much further, diameters of the end parts of the connection pipe (3) are set to be the same or different; and the diameter of the corresponding connection cap (4) is also different when the diameters of the end parts of the connection pipe (3) are different.

A connection method for the connection pipe (3) and the connection cap (4) includes, but is not limited to, the following.

The connection pipe (3) and the connection cap (4) are in threaded connection, and the connection cap (4) rotates by means of a rotating thread;

or, the end part of the connection pipe (3) is sleeved inside the connection cap (4), an inner diameter of the connection cap is greater than the diameter of the end part of the connection pipe (3), and the connection cap (4) rotates by taking the end part of the connection pipe (3) as an axis;

or, the connection cap (4) is set to be a sphere; the sphere is movably embedded at the end part of the connection pipe (3); and the connection pipe (4) rotates in a “ball” form.

Further, the stick body (1) has a fixed length, and two end parts of the stick body (1) are respectively provided with the first holding parts (2).

Further, the length of the stick body (1) is adjustable.

Much further, the body shaping stick is formed by assembling two stick bodies (1) with same or different lengths; the free end of the stick body (1) that is not provided with the first holding part (2) is plugged into the connection pipe (3) of the first holding part (2) of the other stick body (1); and a massage body with a massage function is formed on the first holding part (2) at a joint of the two stick bodies (1);

or, the free ends of the two stick bodies (1) that are not provided with the first holding parts (2) are connected with each other, and a joint is sleeved with a rolling massage body taking the joint as an axis.

Much further, the stick body (1) is set to be a telescopic rod with an adjustable length, and recognition scales are formed on the telescopic rod.

Much further, the telescopic rod is a unidirectional telescopic rod, and includes a first pipe section with a relatively small diameter and a pipe section with a relatively large diameter; the first pipe section with the relatively small diameter is sleeved inside the pipe section with the relatively large diameter; an inner wall of the pipe section with the relatively large diameter or an outer wall of the first pipe section with the relatively small diameter is provided with an anti-falling component which prevents the two pipe sections from falling during stretching and fixes the stretched pipe sections;

or, the telescopic rod includes a pipe section with a relatively small diameter and two pipe sections with relatively large diameters; the pipe sections with the relatively large diameters are sleeved outside the pipe section with the relatively small diameter; and matching anti-falling components are arranged on inner walls of the pipe sections with the relatively large diameters and outer walls of two ends of the pipe section with the relatively small diameter;

or, the telescopic rod includes a pipe section with a relatively large diameter and two pipe sections with relatively small diameters; the pipe section with the relatively large diameter is sleeved outside the pipe sections with the relatively small diameters; and matching anti-falling components are arranged on outer walls of the pipe sections with the relatively small diameters and inner walls of two ends of the pipe section with the relatively large diameter.

Further, an outer surface of the stick body (1) on the inner side of the first holding part (2) is provided with massage particles with antiskid and massage functions to form a second holding part; and a surface of the connection cap (4) is provided with several protruding massage parts (15).

The present disclosure has the beneficial effects below.

(1) The rotatable design of the first holding part can make it rotate under a force from the hand to the palm, and the first holding part has higher flexibility during use. The palm and the arm can do various exercise actions according to the rotating trend of the first holding part, and the rotation of the first holding part also play a massage role on the palm.

The first holding part is removably mounted at the end part of the stick body of the body shaping stick, so one or two holding parts can be selectively mounted according to the need of the user, and this is more humanized. The holding part is designed to be spherical, which is more suitable for human palm's holding and more in line with the human engineering, so that it is favorable for various body shaping exercises. The design of a spherical holding part does not include sharp parts. This instrument is safer during use (particularly when children use it). The spherical shape itself provides psychological security for the user.

(2) The first holding part is formed by removably connecting different types of connection pipes with connection caps. The connection pipe is the linear two-way connection pipe, the curved two-way connection pipe with a certain angle, the three-way connection pipe, the cross type four-way connection pipe, or various different types of other multi-way connection pipes, so that the user can assemble the first holding part according to different needs. For example, diameters of two end parts of the traditional linear connection pipe or an elbow connector are set to be the same. After assembling, the linear or certain angled first holding part, the connection caps at two ends of which have consistent sizes, can be obtained. The diameters of the two end parts of the traditional linear connection pipe or elbow connector can also be set to be different. After assembling, the linear or certain angled first holding part, the connection caps at two ends of which have inconsistent sizes, can be obtained. The angle of the elbow connector can also be adjusted to obtain first holding parts with different angles. During use, a side with a relatively small diameter is set to be a free end, which can lower the use difficulty of a beginner or a child and is suitable for being used by people in different body conditions.

(3) The connection cap is connected to the connection pipe in a manner of threaded connection, so that the connection cap can rotate under relatively low palm acting force, and various types of body shaping motions are easier to conduct.

(4) The body shaping stick is set to have a fixed-length mode and an adjustable-length mode to further improve the use flexibility of the body shaping stick, which is suitable for being used by people in different heights and body conditions. In addition, the length of the body shaping stick is adjusted by means of connecting two stick bodies, and a “massage body” can be formed at the joint. The “massage body” can be used to massage muscles of the arms, the legs and the back. The body shaping stick using the telescopic rod with the scales can be maintained in a relatively short state when not used, and is more convenient to carry. The length can be adjusted by referring to the scales when the body shaping stick is used, so that the adjusted length is clear at a glance.

(5) The first holding parts of different structures can be removed from the body shaping stick and used alone. For example, it can be used as a massage device or a scrapping device. The massage particles arranged on its surface can further enhance the massage effect to eliminate the fatigue or ache in the nape, the head, the thighs, the cruses, and other parts.

(6) The second holding part is also arranged on the inner side of the first holding part. The user can select the holding part according to an own height and body condition. Meanwhile, the user can also adjust the use difficulty of the body shaping stick during use. For example, the user turns hands backwards with the body shaping stick to exercise the arms and the back; when the hands are switched from the first holding part to the second holding part, the turning difficulty will be increased, and the exercise strength is also increased. The massage particles arranged on the second holding part also have a massage function for the palms.

### BRIEF DESCRIPTION OF THE DRAWINGS

FIG. 1 is a schematic overall diagram of a body shaping stick having a stick body with a fixed length;

FIG. 2 is a schematic diagram of a first holding part having connection caps at two ends with the same size;

FIG. 3 is a schematic exploded diagram of a first holding part;

FIG. 4 is a schematic diagram of a connection cap;

FIG. 5 is a schematic diagram of a body shaping stick with a unidirectional telescopic rod serving as a stick body;

FIG. 6 is a schematic diagram of a body shaping stick with a bidirectional telescopic rod serving as a stick body; and

FIG. 7 is a schematic diagram of a body shaping stick which is provided with a bidirectional telescopic rod serving as a stick body and is stretched to the outside.

Reference signs in the drawings: 1: stick body; 2: first holding part; 3: connection pipe; 4: connection cap; 5: clamping connector; 6: clamping clip; 7: protruding head; 8: upper conical surface; 9: lower conical surface; 10: sealing ring; 11: gland; 12: external thread; 13: pressing conical surface; 14: internal thread; 15: massage part.

### DETAILED DESCRIPTION OF THE EMBODIMENTS

The present disclosure is further described below in conjunction with the drawings and specific embodiments.

### Embodiment 1

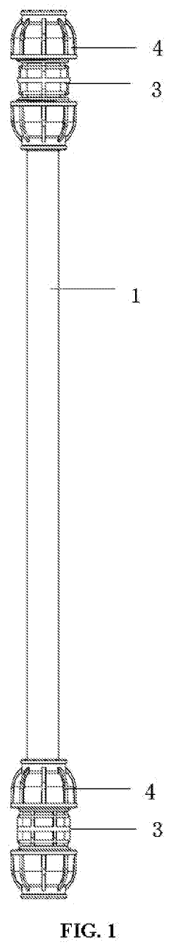

As shown in FIG. 1, a body shaping stick is composed of a stick body 1, first holding parts 2 removably mounted at two ends of the stick body 1, and second holding parts on inner sides of the first holding parts 2. Each second holding part is composed of massage particles a arranged on a surface of the stick body 1. The massage particles a may be set into various shapes, such as a circle or a heart, and also achieves an antiskid effect. The stick body 1 and the first holding part 2 are made of plastic, metal, wood, or the like. The plastic may use PP. In addition, the plastic may also use degradable plastic, such as PBAT, PBS, and PVDF. In order to further reduce the weight, the stick body 1 may be set to be a hollow tubular structure. In addition, the body shaping stick may also be configured with various colors to make it more beautiful.

The first holding part 2 includes a connection pipe 3 and a spherical connection cap 4 rotatably connected to an end part of the connection part 3; the connection pipe 3 is at least provided with two end parts; the connection cap is set to be a through hole structure; and at least one end part of the connection pipe 3 is set to allow the stick body 1 to be plugged and to fix the stick body 1.

A connection method for the connection pipe 3 and the connection cap 4 includes, but is not limited to, the following.

The connection pipe 3 and the connection cap 4 are in threaded connection, and the connection cap 4 rotates by means of a rotating thread;

or, the end part of the connection pipe 3 is sleeved inside the connection cap 4, an inner diameter of the connection cap is greater than the diameter of the end part of the connection pipe 3, and the connection cap 4 rotates by taking the end part of the connection pipe 3 as an axis;

or, the connection cap 4 is set to be a sphere; the sphere is movably embedded at the end part of the connection pipe 3; and the connection pipe 4 rotates in a “ball” form.

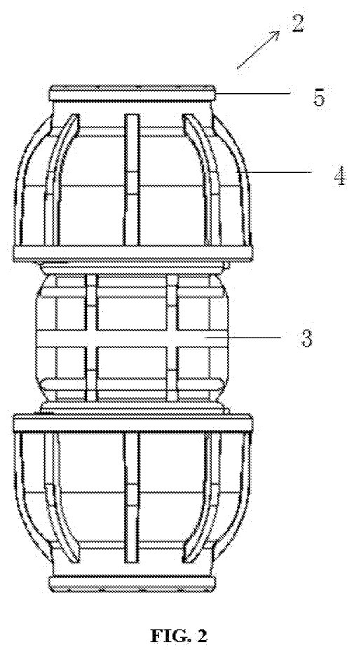

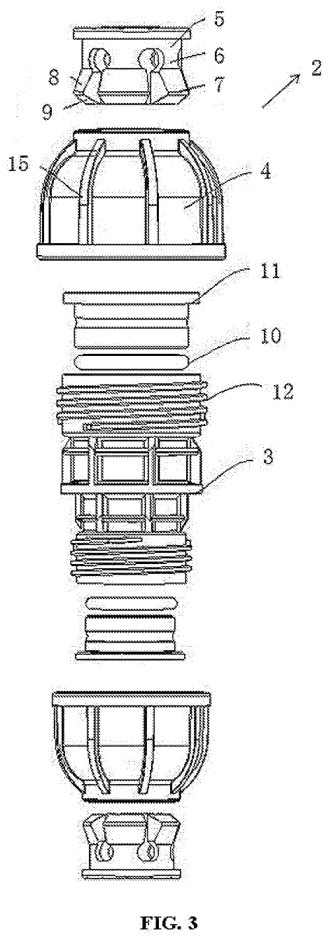

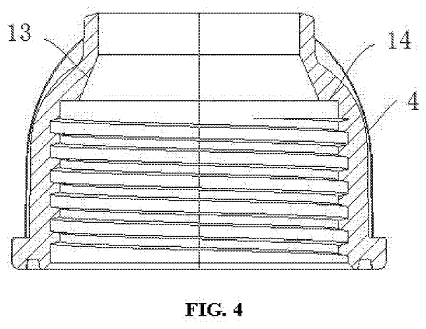

The linear two-way connection pipe and the threaded connection are taken as an example to describe the specific structure of the first holding part in detail. As shown in FIGS. 2-4, the first holding part 2 includes a hollowed connection pipe 3 and spherical connection caps 4 removably connected to two end parts of the connection pipe 3. The connection cap 4 is of a through hole structure. Specifically, a clamping connector 5 is movably mounted in the connection cap 4; the lower part of the clamping connector 5 is provided with a plurality of clamping clips 6 circumferentially distributed; the lower ends of the clamping clips 6 are provided with protruding heads 7; the upper sides of the protruding heads 7 are provided with upper conical surfaces 8, and the lower sides of the protruding heads are provided with lower conical surfaces 9. The connection pipe 3 is of a traditional linear structure, and is provided with limiting bosses at positions close to openings in two ends; sealing rings 10 are arranged on the limiting bosses; the upper ends of the sealing rings 10 are provided with glands 11; external threads 12 are formed on outer walls of the connection pipe 3 at the two ends; and internal threads 14 matched with the external threads 12 are formed on inner walls of the connection caps 4.

A connection process for the stick body 1 and the first holding part 2 is as follows. One end of the stick body 1 is plugged from the clamping connector 5, passes through the gland 11 and the sealing ring 10, and then abuts against the limiting boss. The connection cap 4 is then screwed. In the screwing process, a pressing conical surface 13 of the connection cap 4 abuts against the upper conical surface 8 of the protruding head 7 to drive the clamping clips 6 of the clamping connector 5 to be pressed inwards, and the clamping clips 6 clamp the stick body 1, thereby fixing the stick body 1.

In addition to the linear type, the connection pipe 3 may also be a curved two-way connection pipe with a certain angle, a three-way connection pipe, a multi-way connection pipe, or the like. When the connection pipe 3 is the curved two-way connection pipe, the connection caps 4 are removably connected to two end parts of an elbow connector; and the two connection caps 4 form angled connection. In addition, diameters of the end parts of the connection pipe 3 are set to be the same or different; and the diameters of the corresponding connection caps 4 are also different when the diameters of the end parts of the connection pipe 3 are different. Of course, other end parts of the connection pipe 3 may also be blind holes in addition to the end parts connected to the stick body 1.

Specifically, the linear two-way connection pipe or the curved two-way connection pipe with a certain angle is taken as an example. When the diameters of the two end parts of the connection pipe 3 are set to be the same, the linear or certain angled first holding part 2, the connection caps 4 at two ends of which have consistent sizes, can be assembled by means of the linear two-way connection pipe or the curved two-way connection pipe with a certain angle. When the diameters of the two end parts of the connection pipe 3 are set to be different, the linear or certain angled first holding part 2, the connection caps 4 at two ends of which have inconsistent sizes, can be assembled by means of the linear two-way connection pipe or the curved two-way connection pipe with a certain angle. Or, first holding parts 2 with different angles may also be obtained by means of the angle of the curved two-way connection pipe. In the use process of the body shaping stick, one side of the connection cap with a relatively small diameter is used as a free end.

A surface of the connection cap 4 of the first holding part 2 is provided with several protruding massage parts b. The massage parts b may be set to be strip-type massage ribs or protruding round dots or of any other shapes. The first holding part 2 can be removed from the stick body 1 and used alone. For example, it can be used as a massage device or a scrapping device.

### Embodiment 2

The body shaping stick is formed by assembling two stick bodies 1 with same or different lengths.

Method I: one end part of one stick body 1 is not connected with the first holding part 2. The free end part is connected to the connection pipe 3 of the first holding part 2 of the other stick body 1. At this time, the connection pipe 3 may be the linear two-way connection pipe. A massage body with a massage function is formed on the first holding part 2 at a joint of the two stick bodies 1.

The stick body 1 may have different lengths, such as 30 cm, 50 cm, or 100 cm. When two stick bodies are assembled by the connection pipe 3, an assembling mode may be 30*30 cm, 50*50 cm, or 30*50 cm, or the two stick bodies may be assembled in any other different lengths according to an actual need.

Method II: the free ends of the two stick bodies 1 that are not provided with the first holding parts 2 are connected with each other in any existing connection way, and a joint is selectively sleeved with a rolling massage body taking the joint as an axis.

Other settings are the same as those in Embodiment 1.

### Embodiment 3

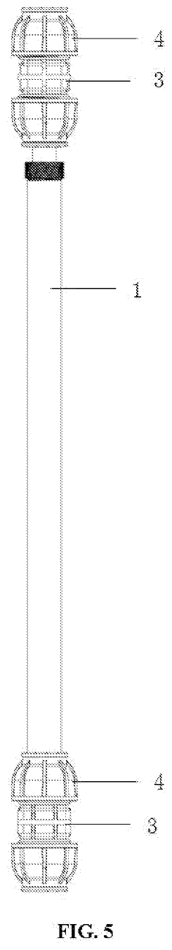

As shown in FIG. 5, the stick body 1 may be a telescopic rod with an adjustable length. The telescopic rod is a unidirectional telescopic rod, and includes a first pipe section with a relatively small diameter and a pipe section with a relatively large diameter; the first pipe section with the relatively small diameter is sleeved inside the pipe section with the relatively large diameter; an inner wall of the pipe section with the relatively large diameter or an outer wall of the first pipe section with the relatively small diameter is provided with an anti-falling component (not shown in the figures). For example, the anti-falling component can be a locating piece on the first pipe section with the relatively small diameter and a locating hole formed in the pipe section with the relatively large diameter and matched with the locating piece. The locating piece may be an elastic protrusion. When not stretched, the protrusion is compressed in the pipe section with the relatively large diameter. When the first pipe section with the relatively small diameter is pulled to the outside, the elastic protrusion can be locked in the locating hole. Similarly, the elastic protrusion may also be arranged on the pipe section with the relatively large diameter, and the locating piece is arranged on the first pipe section with the relatively small diameter.

Optionally, a plurality of elastic protrusions and locating holes matched with the elastic protrusions may also be provided along the circumference of the wall of the pipe section. The protrusions may also be further replaced with elastic convex rings, and the matched locating holes are replaced with ringlike grooves matched with the convex rings. The anti-falling component may also be disposed in any other existing form. The anti-falling component prevents two pipe sections from falling during stretching and fixes the two stretched pipe sections.

Optionally, a second pipe section with a smaller diameter can also be sleeved inside the first pipe section. A third pipe section with a smaller diameter can be sleeved in the second pipe section. The quantity of internal pipe sections can be set according to a need of an actual use length. Much further, scales can be marked on the internal pipe sections to display the length, and a user can adjust the length of the body shaping stick according to the scales.

Other settings are the same as those in Embodiment 1.

### Embodiment 4

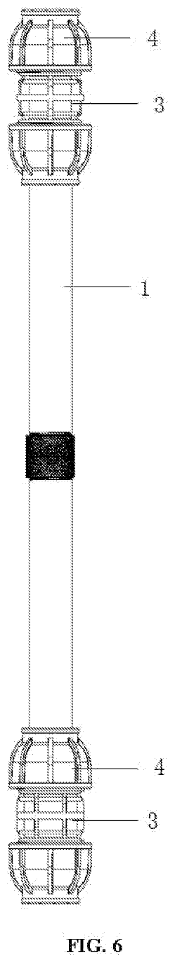

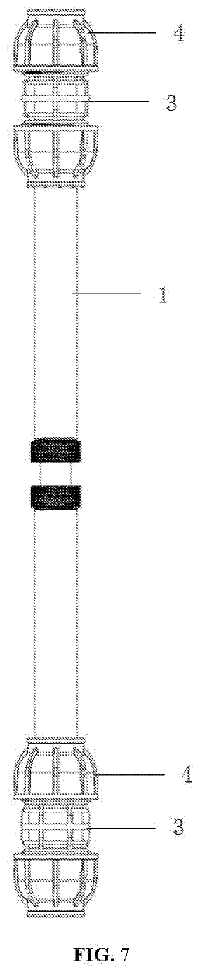

As shown in FIGS. 6 and 7, the stick body 1 may be a telescopic rod with an adjustable length. The telescopic rod is a bidirectional telescopic rod, and includes a pipe section with a relatively small diameter and two pipe sections with relatively large diameters; the pipe sections with the relatively large diameters are sleeved outside the pipe section with the relatively small diameter; and matching anti-falling components (not shown in the figures) are arranged on inner walls of the pipe sections with the relatively large diameters and outer walls of two ends of the pipe section with the relatively small diameter. What is similar to Embodiment 3 that the anti-falling component may be a locating piece on the pipe section with the relatively large diameter and a locating hole formed in the pipe section with the relatively small diameter and matched with the locating piece. The locating piece may be an elastic protrusion. When not stretched, the protrusion is compressed in the pipe section with the relatively large diameter. When the pipe section with the relatively large diameter is pulled to the outside, the elastic protrusion can be locked in the locating hole. Similarly, the elastic protrusion may also be arranged on the pipe section with the relatively small diameter, and the locating piece is arranged on the first pipe section with the relatively large diameter.

In addition, the bidirectional telescopic rod may include two pipe sections with relatively small diameters and a pipe section with relatively large diameter; the pipe section with the relatively large diameter is sleeved outside the pipe sections with the relatively small diameters; and matching anti-falling components (not shown in the figures) are arranged on outer walls of the pipe sections with the relatively small diameters and inner walls of two ends of the pipe section with the relatively large diameter. What is similar to Embodiment 3 that the anti-falling component may be a locating piece on the pipe section with the relatively large diameter and a locating hole formed in the pipe section with the relatively small diameter and matched with the locating piece. The locating piece may be an elastic protrusion. When not stretched, the protrusion is compressed in the pipe section with the relatively small diameter. When the pipe section with the relatively large diameter is pulled to the outside, the elastic protrusion can be locked in the locating hole. Similarly, the elastic protrusion may also be arranged on the pipe section with the relatively large diameter, and the locating piece is arranged on the pipe section with the relatively small diameter.

Optionally, what is similar to Embodiment 3 is that a plurality of elastic protrusions and locating holes matched with the elastic protrusions are provided along the circumference of the wall of the pipe section. The protrusions may also be further replaced with elastic convex rings, and the matched locating holes are replaced with ringlike grooves matched with the convex rings. A pipe section with a smaller diameter may also be sleeved in the internal pipe section, and scales are provided on the internal pipe section.

Other settings are the same as those in Embodiment 1.

According to the body shaping stick provided by the present disclosure, the length can be adjusted and the holding part can be assembled according to ages, heights and body conditions of different users, and the design is more in line with the human engineering. The body shaping stick can be used to do all kinds of training on arm, wrist, back and neck muscles, joints and the like, and can also cooperate with various yoga actions to do various types of stretching, so as to achieve the purposes of relaxing muscles, reducing weight, shaping the body, and the like. The holding part and the stick body can be removed selectively on demand. The removed holding part can be used alone as a massage device or scraping instrument, and the fatigue or ache in the nape, the head, the thighs, the cruses, and other parts can be eliminated after exercises.

The foregoing is only a good and feasible implementation example of the present disclosure and cannot therefore limit the scope of claims of the present disclosure. For those skilled in the art, all other corresponding changes made by using the technical solution and technical idea of the present disclosure shall fall within the scope of protection of the claims of the present disclosure.

What is claimed is:

1. A body shaping stick, comprising a stick body (1), wherein at least one end part of the stick body (1) is provided with a removable first holding part (2); a free end part of the first holding part (2) is at least set to be spherical for a user to hold and conduct various fitness operations; and the free end part of the first holding part (2) may rotate under the action of a force.

2. The body shaping stick according to claim 1, wherein the first holding part (2) comprises a connection pipe (3) and a spherical connection cap (4) rotatably connected to an end part of the connection part (3); the connection pipe (3) is at least provided with two end parts; and at least one end part of the connection pipe (3) is set to allow the stick body (1) to be plugged and to fix the stick body (1).

3. The body shaping stick according to claim 2, wherein the connection pipe (3) comprises a linear two-way connection pipe, a curved two-way connection pipe with a certain angle, or a multi-way connection pipe; and the connection cap (4) is rotatably connected to each end part of the connection pipe (3) to form the first holding part (2) of different structures.

4. The body shaping stick according to claim 3, wherein diameters of the end parts of the connection pipe (3) are set to be the same or different; and the diameter of the corresponding connection cap (4) is also different when the diameters of the end parts of the connection pipe (3) are different.

5. The body shaping stick according to claim 2, wherein a connection method for the connection pipe (3) and the connection cap (4) comprises the following:
the connection pipe (3) and the connection cap (4) are in threaded connection, and the connection cap (4) rotates by means of a rotating thread;
or, the end part of the connection pipe (3) is sleeved inside the connection cap (4), an inner diameter of the connection cap is greater than the diameter of the end part of the connection pipe (3), and the connection cap (4) rotates by taking the end part of the connection pipe (3) as an axis;
or, the connection cap (4) is set to be a sphere; the sphere is movably embedded at the end part of the connection pipe (3); and the connection pipe (4) rotates in a “ball” form.

6. The body shaping stick according to claim 5, wherein the length of the stick body (1) is fixed, and two end parts of the stick body (1) are respectively provided with the first holding parts (2);
or, the length of the stick body (1) is adjustable.

7. The body shaping stick according to claim 6, wherein the body shaping stick is formed by assembling two stick bodies (1) with same or different lengths; the free end of the stick body (1) that is not provided with the first holding part (2) is plugged into the connection pipe (3) of the first holding part (2) of the other stick body (1); and a massage body with a massage function is formed on the first holding part (2) at a joint of the two stick bodies (1);
or, the free ends of the two stick bodies (1) that are not provided with the first holding parts (2) are connected with each other, and a joint is sleeved with a rolling massage body taking the joint as an axis.

8. The body shaping stick according to claim 6, wherein the stick body (1) is a telescopic rod with an adjustable length, and recognition scales are formed on the telescopic rod.

9. The body shaping stick according to claim 8, wherein the telescopic rod is a unidirectional telescopic rod or a bidirectional telescopic rod.

10. The body shaping stick according to claim 2, wherein an outer surface of the stick body (1) on the inner side of the first holding part (2) is provided with massage particles with antiskid and massage functions to form a second holding part; and a surface of the connection cap (4) is provided with several protruding massage parts (15).

11. The body shaping stick according to claim 7, wherein an outer surface of the stick body (1) on the inner side of the first holding part (2) is provided with massage particles with antiskid and massage functions to form a second holding part; and a surface of the connection cap (4) is provided with several protruding massage parts (15).
